(19) United States
(12) Patent Application Publication
(10) Pub. No.: US 2009/0207114 A1
(43) Pub. Date: Aug. 20, 2009

(54) LIQUID CRYSTAL DISPLAY DEVICE

(76) Inventor: Kimitaka Terasaka, Ishikawa-ken (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/388,308

(22) Filed: Feb. 18, 2009

(30) Foreign Application Priority Data
Feb. 19, 2008 (JP) P2008-037875

(51) Int. Cl. G02F 1/13357; G09G 3/36

(52) U.S. Cl. 345/89; 349/62; 345/102

(57) ABSTRACT

A liquid crystal display device includes: a liquid crystal display panel having a matrix of pixels arranged in rows and columns; a light unit overlapping the liquid crystal display panel to illuminate the liquid crystal display panel, including a light guide plate composed of a plurality of light guide blocks; and a video signal output unit for outputting a first video signal to pixels facing the light guide blocks and a second video signal to pixels facing a gap between adjacent light guide blocks, respectively, wherein the video signal output unit provides the second video signal corrected to correspond to a corrected gradation value.

### CROSS-REFERENCE TO RELATED APPLICATIONS

This application is based upon and claims the benefit of priority from prior Japanese Patent Application No. 2008-037875, filed Feb. 19, 2008, the entire contents of which are incorporated herein by reference.

### TECHNICAL FIELD

The present invention relates generally to a liquid crystal display device, and more particularly to a light unit having a light guide plate including a plurality of light guide blocks.

### BACKGROUND OF THE INVENTION

A liquid crystal display device is widely used in various fields of electrical equipment as a flat-screen display device, providing such advantages as lightness, a thin profile, and low power consumption. A transmissive type liquid crystal device includes a back light unit for illuminating the liquid crystal panel from the back side. Such transmissive type liquid crystal devices display pictures, in which a light from the light unit is selectively transmitted through each cell of the liquid crystal device to the viewer.

In such a liquid crystal device, when moving pictures are displayed, the traces of the moving pictures are easily left. In order to solve such problem, Japan KOKAI Patent 2001-92370 discloses one technology in which a plurality of light guide plates are arranged in parallel with each other and LEDs are embedded at the edge of each light guide plate. The timing to light the LEDs is synchronized with the timing to supply voltages to the liquid crystal panel.

### BRIEF SUMMARY OF THE INVENTION

The present invention has been made to solve above-mentioned problems and provide a liquid crystal display device, in which the ununiformity of brightness of the pixels caused by the gap between adjacent light guide blocks in the displayed pictures becomes barely recognized, which leads to an improvement of display quality.

According to one aspect of the invention, there is provided a liquid crystal display device comprising: a liquid crystal display panel having a matrix of pixels arranged in rows and columns; a light unit overlapping the liquid crystal display panel to illuminate the liquid crystal display panel, including a light guide plate composed of a plurality of light guide blocks; and a video signal output unit for outputting a first video signal to pixels facing the light guide blocks and a second video signal to pixels facing a gap between adjacent light guide blocks, respectively, wherein the video signal output unit provides the second video signal corrected to correspond to a corrected gradation value.

According to a second aspect of the invention, there is provided a liquid crystal display device comprising: a liquid crystal display panel having a matrix of pixels arranged in rows and columns; a light unit overlapping the liquid crystal display panel and to illuminate the liquid crystal display panel, including a light guide plate composed of a plurality of light guide blocks; a light source provided at an edge of the light guide blocks; and a video signal output unit for outputting a first video signal to pixels facing the light guide blocks and a second video signal to pixels facing a gap between adjacent light guide blocks, respectively, wherein the video signal output unit provides the second video signal corrected to correspond to a corrected gradation value to improve uniformity of brightness of the pixels.

According to a third aspect of the invention, there is provided a liquid crystal display device comprising: a liquid crystal display panel having a matrix of pixels arranged in rows and columns; a light unit overlapping the liquid crystal display panel to illuminate the liquid crystal display panel, including a light guide plate composed of a plurality of light guide blocks; and a video signal output unit for outputting a first video signal to pixels facing the light guide blocks and a second video signal to pixels facing a gap between adjacent light guide blocks, respectively, wherein the video signal output unit includes a video signal processing circuit for converting a video signal to a corrected video signal by correcting a gradation value using a correction value stored in a memory unit and a line number of pixels arranged in a row direction to which the video signals are supplied, to improve uniformity of brightness of the pixels.

According to a fourth aspect of the invention there is provided a liquid crystal display device comprising: a liquid crystal display panel having a matrix of pixels arranged in rows and columns; a light unit overlapping the liquid crystal display panel to illuminate the liquid crystal display panel, including a light guide plate composed of a plurality of light guide blocks; and a video signal output unit for outputting a first video signal to pixels facing the light guide blocks and a second video signal to pixels facing a gap between adjacent light guide blocks, respectively, wherein the video signal output unit includes a video signal processing circuit for converting a video signal to a corrected video signal by correcting a gradation value using a correction value stored in a memory unit and a line number of pixels arranged in a row direction, to which the video signals are supplied, wherein a plurality of pixel row lines face to respective ones of the gaps between adjacent light guide blocks and the corrected video signals are supplied to the plurality of the pixel row lines.

### BRIEF DESCRIPTION OF THE DRAWINGS

The accompanying drawings, which are incorporated in and constitute a part of the specification, illustrate presently preferred embodiments of the invention, and together with the general description given above and the detailed description of the preferred embodiments given below, serve to explain the principles of the invention.

FIG. 1 is a diagram showing schematically the structure of a liquid crystal display device according to a first embodiment of the present invention;

FIG. 2 is a cross-sectional view showing schematically the structure of the liquid crystal display panel shown in FIG. 1;

FIG. 3 is a perspective view showing construction of a light guide plate of a light unit in the liquid crystal device shown in FIG. 1;

FIG. 4 is a perspective view explaining a correspondence between a gap between adjacent light guide blocks of the light unit and pixels facing the gap in which the light unit and the liquid crystal panel are stacked;

FIG. 5 is a schematic block diagram showing a process for correcting video signals supplied to the pixels facing the gap between adjacent light guide blocks;

FIG. 6 is a table showing gradation values before correction and after correction, and correction values used to correct the gradation values in the first embodiment; and

FIG. 7 to FIG. 10 are tables showing the gradation values before correction and after correction, and the correction values used to correct the gradation values in other embodiments.

### DETAILED DESCRIPTION OF THE INVENTION

A display device according to an embodiment of the present invention, in particular, a liquid crystal display device, will now be described with reference to the accompanying drawings.

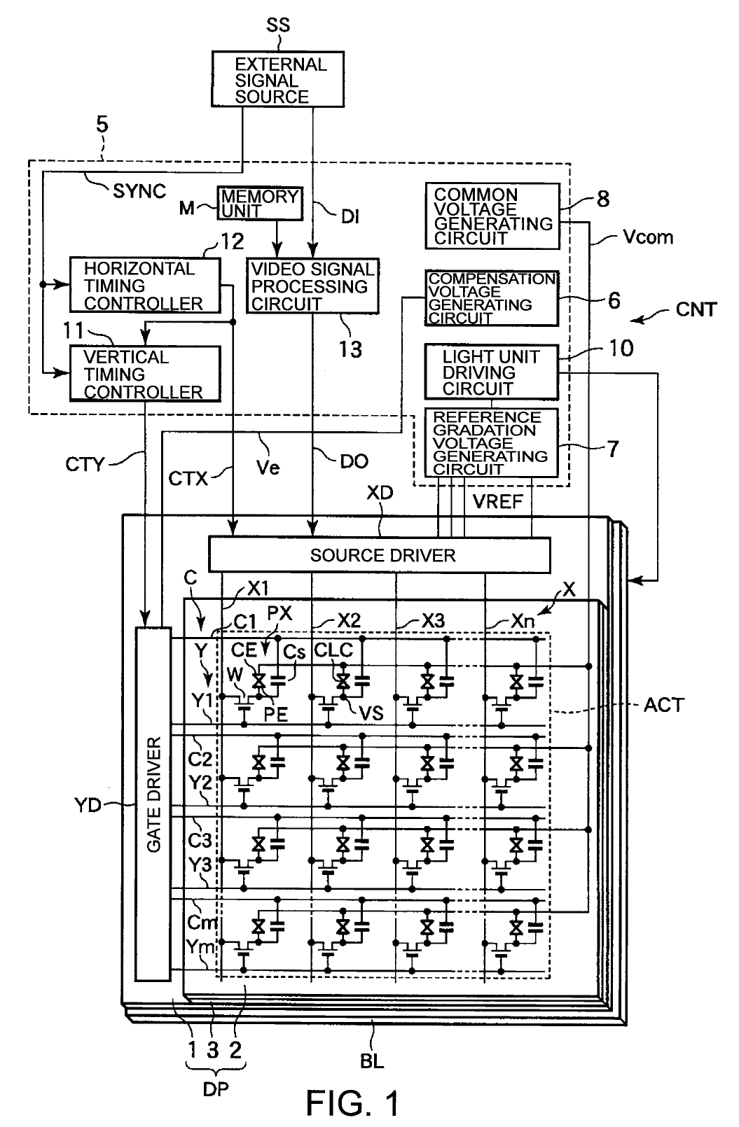

FIG. 1 is a diagram showing schematically the structure of a liquid crystal display device according to a first embodiment of the present invention. As shown in FIG. 1, a first embodiment will be explained referring to a transmissive type liquid crystal device in which pictures are displayed by selectively transmitting light from a light unit.

The illustrated liquid crystal device includes a transmissive type display panel DP, a light unit, e.g., a back light unit BL for illuminating the display panel DP, and a control unit CNT for controlling the display panel DP and the back light unit BL. In the liquid crystal panel DP, a liquid crystal layer 3 is held between a pair of substrates, e.g., an array substrate 1 and a counter substrate 2. Further, the liquid crystal device includes an active area ACT having a plurality of pixels PX arranged in a matrix shape for displaying pictures.

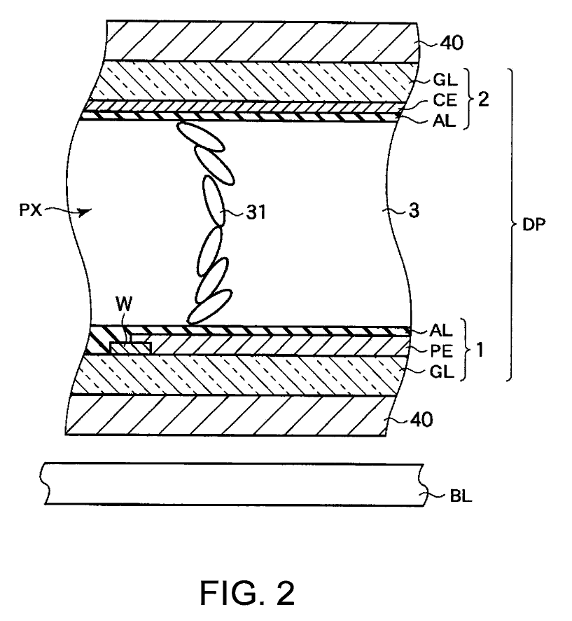

FIG. 2 is a cross-sectional view showing schematically the structure of the liquid crystal display panel shown in FIG. 1. As shown in FIG. 2, the array substrate 1 includes an insulating substrate GL such as a glass substrate. Moreover, the array substrate 1 includes a plurality of pixel electrodes PE, an alignment film AL formed on the pixel electrodes PE and the like.

As shown in FIG. 1, the array substrate 1 also includes a plurality of scanning lines Y (1, 2, 3, . . . , m), e.g., gate lines Y, which extend in a row direction of the pixels PX; a plurality of source lines, e.g., signal lines X (1, 2, 3, . . . , n) which extend in a column direction of the pixels PX and cross the scanning lines Y so as to interpose a dielectric layer therebetween; switching elements W (m×n) which are disposed near the intersections of the scanning lines Y and the signal lines X; and a plurality of capacitor lines C (C1 to Cm) on the insulating substrate GL in the active area. The gate lines Y and the capacitor lines C are alternately arranged in parallel with each other. The switching elements W are formed by thin film transistors (TFTs), each of which includes a semiconductor layer made of amorphous silicon or polysilicon. The gate electrodes of the switching elements W are electrically connected to the corresponding scanning lines Y (gate lines Y), respectively. The source electrodes of the switching elements W are connected to the corresponding signal lines X (source lines X), respectively. The drain electrodes of the switching elements W are connected to the pixel electrodes PE of the pixels PX.

The switching elements W are rendered conductive to pass a pixel voltage to the pixel electrodes PE from the selected source lines when a selected voltage is supplied to the gate electrodes of the switching elements W. The pixel electrodes PE of the pixels PX are made of electrically conductive material such as aluminum (Al) with light reflective characteristics, or indium tin oxide (ITO) and indium zinc oxide (IZO) with light transmissive characteristics.

As shown in FIG. 2, the counter substrate 2 includes an insulating substrate such as a glass substrate GL, a counter electrode CE, for example, which is disposed in common on the glass substrate for all pixels, and an alignment layer AL formed thereon. Some portions of the pixel electrodes PE and the counter electrode CE on the glass substrate GL are made of conductive material with light transmissive characteristics such as indium tin oxide (ITO). In a color type liquid crystal display, a color filter layer is made of resin materials which are colored in a plurality of colors, for example, in the three primary colors of red (R), green (G) and blue (B). The red color resin, green color resin and blue color resin are disposed in association with a red pixel, a green pixel and a blue pixel, respectively. The color filter layer may be disposed on the array substrate 1 or the counter substrate 2. The counter substrate 2 includes a black matrix for shielding the area between the pixels and a shield layer for shielding the peripheral area.

The array substrate 1 and the counter substrate 2 are glued together with a seal member, in which a predetermined gap is created by using a spacer like a columnar spacer, not shown, between the array substrate 1 and the counter substrate 2 outside the active area ACT.

The liquid crystal layer 3 is made of liquid crystal molecules 31 which have positive dielectric anisotropic and optically positive uniaxial characteristics. In this embodiment, the liquid crystal panel uses an OCB (Optically Compensated Bend) mode to conduct switching operations.

When the liquid crystal display device is used for a TV receiver that principally displays moving images, a liquid crystal display panel DP in the OCB mode, in which the liquid crystal molecules 31 exhibit good responsiveness, is generally used. In the liquid crystal display panel DP, the liquid crystal molecules 31 in the OCB mode are in a splay alignment before supply of power. The splay alignment is a state in which the liquid crystal molecules 31 are laid down. The liquid crystal display panel DP performs an initializing process upon supply of power. In this process, a relatively strong electric field is applied to the liquid crystal molecules 31 to change the splay alignment to a bend alignment. A display operation is performed after the initializing process. The liquid crystal molecules 31 are in the splay alignment before the supply of power because the splay alignment is more stable than the bend alignment in terms of energy in a state in which a liquid crystal driving voltage is not applied. As a characteristic of the liquid crystal molecules 31 in the OCB mode, the bend alignment tends to be inverse-transferred to the splay alignment if no voltage is supplied or a voltage lower than a predetermined voltage is supplied. The viewing angle characteristic of the splay alignment significantly differs from that of the bend alignment. Thus, a normal display is not attained with this splay alignment.

In order to avoid the inverse-transfer from the bend alignment to the splay alignment, a high voltage is applied to the liquid crystal molecules 31, for example, in a part of a frame period to display a 1-frame picture. This high voltage corresponds to a pixel voltage for a black display in an OCB-mode liquid crystal display panel, which is a normally-white type. Thus, this driving method is called “black insertion driving.”

Each of the liquid crystal pixels PX has a liquid crystal capacitor CLC between its associated pixel electrode PE and counter electrode CE, and the pixel electrode PE is connected to one end of one of associated storage capacitors Cs. Each storage capacitor Cs is formed by capacitive-coupling between the pixel electrode PE of each pixel PX and an associated one of the capacitor lines C. The capacitance of each storage capacitor Cs is sufficiently greater than the parasitic capacitance of the pixel switching element W.

As shown in FIG. 2, the liquid crystal device includes an optical compensation element 40 for compensating for the retardation of the liquid crystal layer 3 made of the liquid crystal molecules 31 in the bend alignment. In the transmissive type liquid crystal panel DP, the optical compensation elements 40 are arranged in pairs. That is, while one optical compensation element 40 is arranged between the liquid crystal panel DP and the backlight unit BL (e.g., outside of the array substrate 1), the other optical compensation element 40 is arranged on the viewer's side (e.g., outside of the counter substrate 2).

As shown in FIG. 1, the display panel control unit CNT functions as a video signal output unit for supplying a video signal to each pixel PX of the liquid crystal panel DP. Thereby, a liquid crystal driving voltage is supplied between the array substrate 1 and the counter substrate 2 and the transmissivity of the liquid crystal panel DP is controlled.

The display panel control circuit CNT includes a gate driver YD that sequentially drives the gate lines Y1 to Ym so as to turn on the switching elements W in a row-by-row manner; a source driver XD that outputs pixel voltages Vs to the source lines X1 to Xn in a period in which the switching elements W in each row are driven via the associated gate line Y; and a controller 5.

The controller 5 generates a driving voltage for the liquid crystal panel DP and controls the backlight unit BL, the gate driver YD and the source driver XD. Further, the controller 5 includes a compensation voltage generating circuit 6 which generates a compensation voltage Ve which is supplied to the capacitor line C via the gate driver YD; a reference gradation voltage generating circuit 7 for generating a predetermined number of reference gradation voltages VREF that are used in the source driver XD in order to convert image data into pixel voltage Vs; a common voltage generating circuit 8 for generating a common voltage Vcom; and a light unit driving circuit 10 for controlling the driving of the light source of the back light unit BL.

The control circuit 5 further includes a vertical timing controller 11 for generating a control signal CTY supplied to the gate driver YD according to a synchronizing signal SYNC which is supplied from an external signal source SS; a horizontal timing controller 12 for generating a control signal CTX according to the synchronizing signal SYNC to control the source driver XYD; and a video signal processing circuit 13 for processing the digital image data provided by the external signal source SS.

Under the control of the control signal CTY, the gate driver YD sequentially selects the gate lines Y1 to Ym in every 1-frame period. The control signal CTX is supplied to the source driver XD which outputs a converted pixel voltages Vs corresponding to gradations based on the predetermined number of the reference gradation voltages VREF from the reference gradation voltage generating circuit 7, to the source lines X1 to Xn in a period in which the switching elements W in each row are driven. The control signal CTY designates the polarity of the video signals supplied to the selected pixels PX.

The polarity of the pixel voltage Vs, which is supplied to the pixel electrode PE, is inversely related to the polarity of the voltage supplied to the counter electrode CE to conduct a frame reverse driving or a line reverse driving.

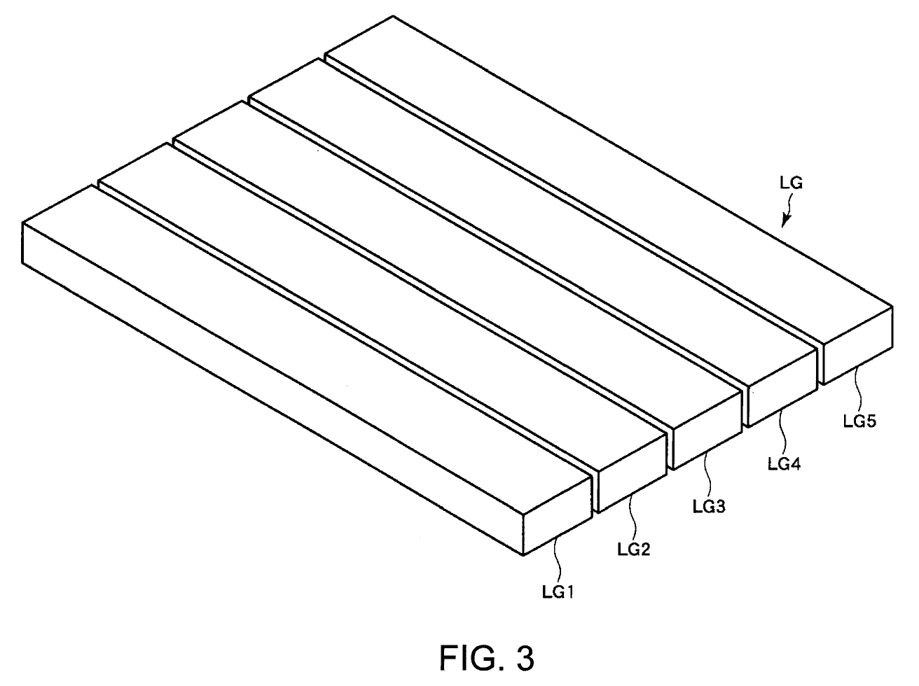

FIG. 3 is a perspective view showing construction of a light guide plate of a light unit in the liquid crystal device shown in FIG. 1 As shown in FIG. 3, and in accordance with the first embodiment, the back light unit BL includes a light guide plate LG including a plurality of light guide blocks. The light guide plate LG may include five light guide blocks LG1-LG5 which each have the same rectangular shape in a plane facing the liquid crystal panel DP. The long side and the short side of each block are arranged in a row direction and a column direction of the liquid crystal panel DP, respectively. Each block may be made of a resin material such as acryl and polycarbonate resin. The light guide blocks are arranged in parallel in the row direction.

The back light unit BL includes light sources arranged in association with the light guide blocks. The light sources may be arranged at an edge of the light guide blocks and may also be arranged on the back side of the light guide blocks (i.e., on the opposite side of the surface facing the liquid crystal panel). The light sources may be provided as LEDs or cold cathode fluorescent lamps (CCFLs).

The back light unit BL includes optical sheets such as diffusion sheets, lens sheets or sheets having multiple functions. The back light unit BL may be provided with a reflective sheet on the back surface of the light guide plate LG. The liquid crystal panel DP may be stacked on the back light unit BL. That is, the back light unit BL may be arranged in such a way that the long side of each block is in parallel with the row direction of the liquid crystal panel DP. As a result, the gap between adjacent light guide blocks faces pixels aligned in the row direction of the liquid crystal panel DP.

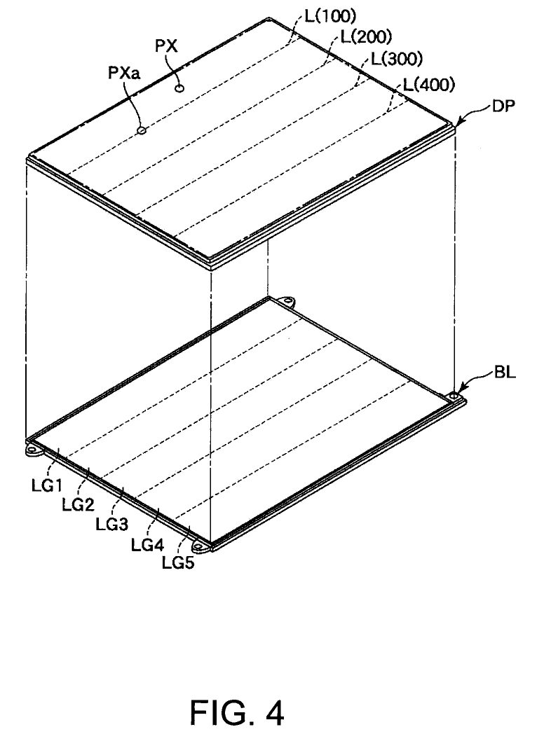

FIG. 4 is a perspective view explaining a correspondence between a gap between adjacent light guide blocks of the light unit and pixels facing the gap in which the light unit and the liquid crystal panel DP are stacked. The liquid crystal panel DP may include, for example, 480 pixel lines arranged in the row direction of the liquid crystal panel DP in the active area ACT. In this case, as shown in FIG. 4, the gap between the light guide blocks LG1 and LG2 faces the 100th pixel line (PXa) arranged in the row direction. The gap between the light guide blocks LG2 and LG3 corresponds to the 200th pixel line. Similarly, the gaps between the light guide blocks LG3 and LG4 and the light guide blocks LG4 and LG5 correspond to the 300th and 400th pixel row lines, respectively.

Lack of uniformity of brightness of a displayed picture may appear between the pixels facing each of the light guide blocks LG1-LG5 and the pixels facing each of the gaps between adjacent light guide blocks, even though video signals supplied to the pixels have the same gradation values, that is, the same pixel voltages Vs are supplied to all pixels. For example, while the illuminating light from the light source is sufficiently guided to the pixels PX facing each of the light blocks LG1-LG2, the illuminating light may not be sufficiently guided to the pixels PXa facing the gap between the light guide blocks LG1 and LG2. As a result, the brightness of the pixel PXa becomes lower than that of the pixel PX.

In the first embodiment, the display control circuit CNT is configured to output video signals to pixels facing each block and also output corrected video signals to pixels facing each gap between adjacent light guide blocks, corresponding to the gradation of the pixels. Thereby, some voltages corresponding to the corrected video signals are supplied to the pixels PXa so as to compensate for the lack of uniformity of the brightness caused by the pixels PXa facing the gaps between adjacent light guide blocks. Accordingly, the influence on the display, i.e., the appearance of dark lines, caused by the gaps between adjacent light guide blocks becomes barely noticeable, which leads to an improvement in display quality.

The display control circuit CNT includes the video signal processing circuit 13 that functions as a signal correction unit and a memory unit M for storing a table that sets the correction value for each gradation necessary to correct the video signals supplied to the pixels PXa.

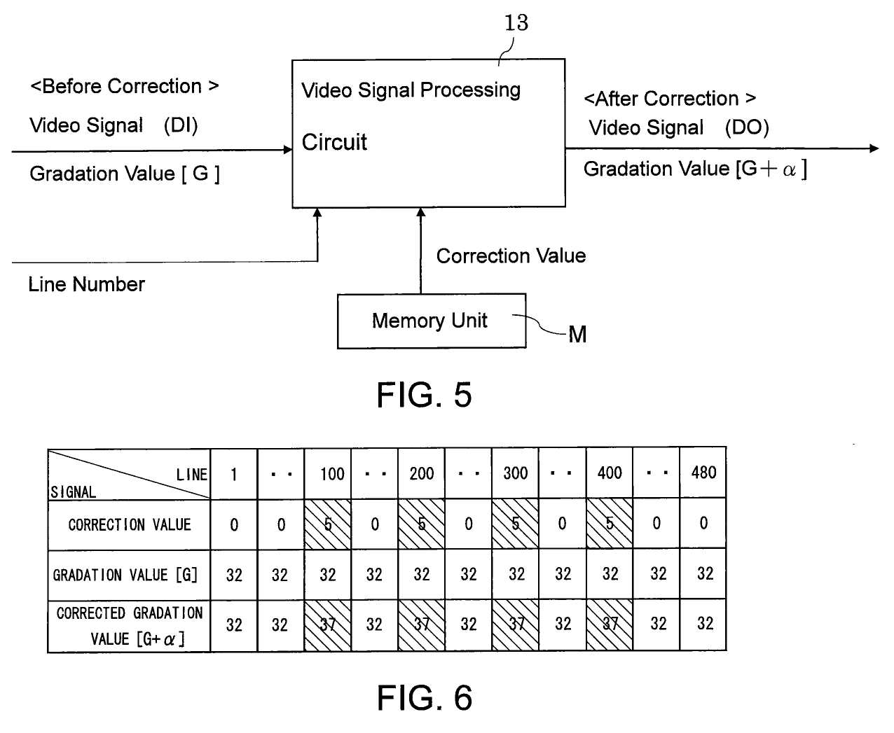

FIG. 5 is a schematic block diagram showing a process for correcting video signals supplied to the pixels facing the gap between adjacent light guide blocks. As shown in FIG. 5, the signal processing circuit 13 obtains from the table stored in the memory unit M a correction value corresponding to the gradation of an input video signal DI supplied to the pixels PXa facing the gap between adjacent light guide blocks. Then, the signal processing circuit 13 corrects the gradation value [G] of the input video signal DI using the correction value and the line number of the pixels PXa. That is, the gradation value of signal DI is corrected to a corrected gradation value [G+α]. Next, the signal processing circuit 13 outputs a corrected video signal DO, corresponding to the corrected gradation value, to the source driver XD. The source driver XD outputs the corrected video signal to each of the pixels PXa arranged in one selected row at the timing when each of the pixel rows (L100, L200, L300, L400) facing the gaps between adjacent light guide blocks is selected.

That is, the gate driver YD outputs selection signals to sequentially select each gate line Y. At the timing when the gate driver YD outputs the selection signals to select the gate lines Y100, Y200, Y300, Y400 corresponding to the pixel row lines (L100, L200, L300, L400), the switching element W is rendered conductive and the source-drain path is formed. In this stage, the source driver XD converts the corrected video signal DO from the video signal processing circuit 13 to a pixel voltage Vs corresponding to the corrected gradation, and supplies the pixel voltage to a plurality of source lines X1 to Xn in parallel, referring to the predetermined numbers of the reference gradation voltage VREF supplied from the reference gradation voltage generating circuit 7. As a result, the corrected pixel voltage corresponding to the corrected video signal is supplied to the pixel electrode PE of each pixel PXa.

With this driving method, it is possible to display pictures with uniform brightness when the entire panel is displayed using substantially the same value of gradations for all pixels.

More detailed examples will be explained hereafter, in which the number of gradations is 256; the gradation values “0” and “255” correspond to the display of “black” and “white”, respectively; and a correction value “5” for the gradation value “32” of the video signal DI, which is supplied to the signal processing circuit 13, is set in the table stored in the memory unit M.

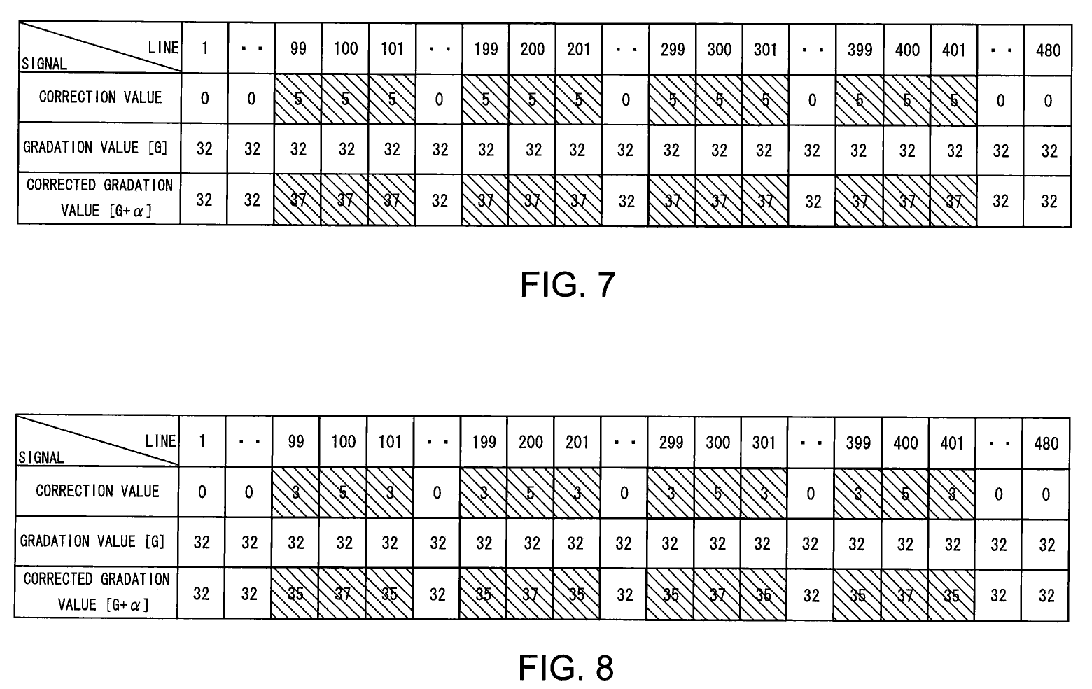

FIG. 6 is a table showing gradation values before correction and after correction, and correction values used to correct the gradation values in the first embodiment. As shown in FIG. 6, when the video signals DI for all pixels of the entire panel having substantially the same gradation value “32” are supplied to the signal processing circuit 13, at the timing when the row lines L1-L99 (i.e., the gate lines Y1-Y99) are selected, the signal processing circuit 13 outputs video signals DO corresponding to the gradation value 32 to selected source lines X. On the other hand, at the timing when the row line L100 (i.e., the gate line Y100) is selected, the signal processing circuit 13 determines a larger gradation value “37” by adding a correction value “5” in the table and outputs a corrected video signal DO corresponding to the gradation value “37”to the selected source lines X.

Similarly, at the timing when the row lines L101-L199 (i.e., gate lines Y101-Y199) are selected, the video signals DO corresponding to the gradation value “32” are output to the selected source lines X. Then, at the timing when the row line L200 (i.e., the gate lines Y200) is selected, a video signal DO corresponding to the gradation value “37”, determined by correcting the video signal DI, is output.

Next, the video signals DO corresponding to the gradation values “32” and “37” for the row lines L201-L299 and L300 are output, respectively. Similarly, the video signals DO corresponding to the gradation values “32” and “37” for the row lines L301-L399 and L400 are output, respectively. Finally, the video signals DO corresponding to the gradation value “32” for the row lines L401-L480 are output.

As described above, if the brightness of the pixels PXa facing the gap between adjacent light guide blocks is lower than that of the pixels PX facing the light guide blocks though the video signals having the same gradation value are supplied to all pixels on the display panel, it is possible to avoid an unfavorable display, i.e., the appearance of dark lines, by setting the gradation of the video signals DO to the corrected higher values than that before correction.

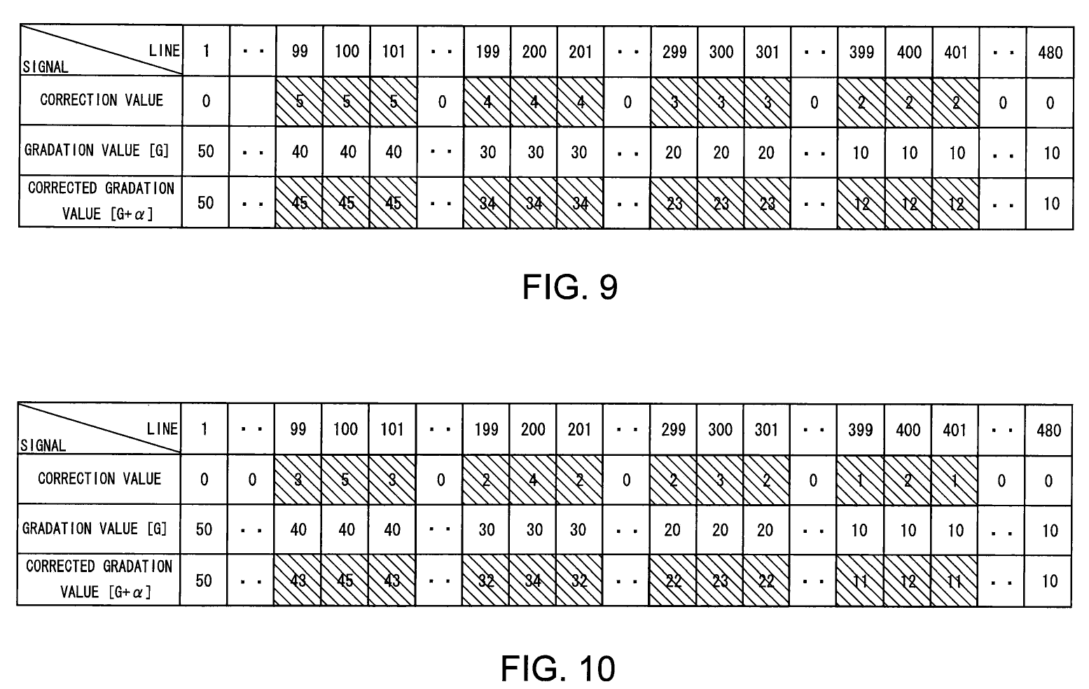

FIG. 7 shows a table stored in the memory unit M, according to another embodiment of the invention. In this embodiment, pixels arranged in three row lines, for example, lines 99-101, face the gap between adjacent light guide blocks and the correction processing is performed for three row lines using the correction value “5” for the three lines 99-101.

With reference to FIG. 8, if the brightness of the pixels arranged in the center row line 100 is the lowest among the three row lines 99-101, the correction values “5” and “3” are used for the row line 100, and the row lines 99 and 101, respectively, by setting the correction value corresponding to the distribution of the brightness.

In general, when images corresponding to the gradation value around “256” (the display of “White”) are displayed, the difference in brightness between the pixels PXa and PX is more easily discerned than that corresponding to the gradation value around “0” (the display of “Black”). Therefore, it is desirable to set the correction value smaller for the gradation of low brightness (first gradation value) than that of high brightness (second gradation value larger than the first gradation value).

FIG. 9 shows a table stored in the memory unit M according to another embodiment of this invention. In this table, a larger correction value of “5” is used as the gradation value of higher brightness (lines 99-101), while a correction value of “2” is used as the gradation value of lower brightness (lines 399-401).

FIG. 10 shows a table in the memory unit M, in which the correction values are set so as to correspond to the distribution of the brightness among three row lines in FIG. 9. The correction values (“5”, “4”, “3”, “2”) of center row lines (L100, L200, L300, L400) of each group of three row lines, are the largest among the three row lines in each group.

According to these embodiments, more complete display can be obtained, without being affected by the lack of uniformity of the emitted light from the backlight unit.

The present invention is not limited by the above-described embodiments. In practice, the structural elements can be modified without departing from the spirit of the invention. Various inventions can be made by properly combining the structural elements disclosed in the embodiments. For example, some structural elements may be omitted from all the structural elements disclosed in the embodiments. Furthermore, structural elements in different embodiments may properly be combined.

What is claimed is:

1. A liquid crystal display device comprising:
a liquid crystal display panel having a matrix of pixels arranged in rows and columns;
a light unit overlapping the liquid crystal display panel to illuminate the liquid crystal display panel, including a light guide plate composed of a plurality of light guide blocks; and
a video signal output unit for outputting a first video signal to pixels facing the light guide blocks and a second video signal to pixels facing a gap between adjacent light guide blocks, respectively,
wherein the video signal output unit provides the second video signal corrected to correspond to a corrected gradation value.

2. The liquid crystal display device according to claim 1, wherein the video signal output unit includes a memory unit having a table to store correction values necessary to correct the video signal supplied to the pixels facing the gap between the adjacent light guide blocks and a video signal processing circuit for correcting the video signal supplied to the pixels facing the gap between the adjacent light guide blocks using the correction values corresponding to the corrected gradation value, to provide the second video signal.

3. The liquid crystal display device according to claim 2, wherein the video signal processing circuit corrects an original gradation value so that a displayed brightness corresponding to the corrected gradation value is higher than the brightness corresponding to the original gradation value.

4. The liquid crystal display device according to claim 2, wherein the correction value corresponding to a first gradation is smaller than the correction value corresponding to a second gradation to display a higher brightness.

5. The liquid crystal display device according to claim 1, wherein the liquid crystal display panel includes a liquid crystal layer having liquid crystal molecules between a pair of substrates for controlling transmittance, the liquid crystal display panel operable in an OCB (Optically Compensated Bend) mode in which the liquid crystal molecules are arranged in a bend alignment when an electric field is applied to the liquid crystal molecules.

6. The liquid crystal display device according to claim 1, wherein the video signal output unit outputs the second video signal to pixels arranged in selected row lines of the liquid crystal display panel at a timing when the pixels facing the gap between the adjacent light guide blocks are selected.

7. A liquid crystal display device comprising:
a liquid crystal display panel having a matrix of pixels arranged in rows and columns;
a light unit overlapping the liquid crystal display panel and to illuminate the liquid crystal display panel, including a light guide plate composed of a plurality of light guide blocks;
a light source provided at an edge of the light guide blocks; and
a video signal output unit for outputting a first video signal to pixels facing the light guide blocks and a second video signal to pixels facing a gap between adjacent light guide blocks, respectively,
wherein the video signal output unit provides the second video signal corrected to correspond to a corrected gradation value to improve uniformity of brightness of the pixels.

8. The liquid crystal display device according to claim 7, wherein the light source includes a light emitting diode (LED).

9. The liquid crystal display device according to claim 7, wherein the light source includes a cold cathode fluorescent lamp (CCFL).

10. The liquid crystal display device according to claim 7, wherein the liquid crystal display panel includes a liquid crystal layer having liquid crystal molecules between a pair of substrates for controlling transmittance, the liquid crystal display panel operable in an OCB (Optically Compensated Bend) mode in which the liquid crystal molecules are arranged in a bend alignment when an electric field is applied to the liquid crystal molecules.

11. A liquid crystal display device comprising:
a liquid crystal display panel having a matrix of pixels arranged in rows and columns;
a light unit overlapping the liquid crystal display panel to illuminate the liquid crystal display panel, including a light guide plate composed of a plurality of light guide blocks; and
a video signal output unit for outputting a first video signal to pixels facing the light guide blocks and a second video signal to pixels facing a gap between adjacent light guide blocks, respectively,
wherein the video signal output unit includes a video signal processing circuit for converting a video signal to a corrected video signal by correcting a gradation value using a correction value stored in a memory unit and a line number of pixels arranged in a row direction to which the video signals are supplied, to improve uniformity of brightness of the pixels.

12. A liquid crystal display device comprising:
a liquid crystal display panel having a matrix of pixels arranged in rows and columns;
a light unit overlapping the liquid crystal display panel to illuminate the liquid crystal display panel, including a light guide plate composed of a plurality of light guide blocks; and
a video signal output unit for outputting a first video signal to pixels facing the light guide blocks and a second video signal to pixels facing a gap between adjacent light guide blocks, respectively,
wherein the video signal output unit includes a video signal processing circuit for converting a video signal to a corrected video signal by correcting a gradation value using a correction value stored in a memory unit and a line number of pixels arranged in a row direction, to which the video signals are supplied,
wherein a plurality of pixel row lines face to respective ones of the gaps between adjacent light guide blocks and the corrected video signals are supplied to the plurality of the pixel row lines.

13. The liquid crystal display device according to claim 12, wherein the same correction values are used to correct the video signals for the plurality of pixel row lines.

14. The liquid crystal display device according to claim 12, wherein the correction values are set corresponding to a distribution of brightness of the plurality of pixel row lines.

15. The liquid crystal display device according to claim 12, further comprising a light source provided at an edge of the light guide blocks.

16. The liquid crystal display device according to claim 15, wherein the light source includes a light emitting diode (LED).

17. The liquid crystal display device according to claim 15, wherein the light source includes a cold cathode fluorescent lamp (CCFL).

18. The liquid crystal display device according to claim 15, wherein a timing to turn on the light source is synchronized with the timing to display the corresponding pixel row lines.

19. The liquid crystal display device according to claim 12, wherein the number of pixel row lines is three.

20. The liquid crystal display device according to claim 12, wherein the liquid crystal display panel includes a liquid crystal layer having liquid crystal molecules between a pair of substrates for controlling transmittance, the liquid crystal display panel operable in an OCB (Optically Compensated Bend) mode in which the liquid crystal molecules are arranged in a bend alignment when an electric field is applied to the liquid crystal molecules.
